(19) United States
(12) Patent Application Publication
(10) Pub. No.: US 2021/0256619 A1
(43) Pub. Date: Aug. 19, 2021

(54) STRUCTURED FINANCE MECHANISM

(71) Applicant: Warren S. DuBose, Raleigh, NC (US)

(72) Inventor: Warren S. DuBose, Raleigh, NC (US)

(21) Appl. No.: 17/174,977

(22) Filed: Feb. 12, 2021

Related U.S. Application Data
(60) Provisional application No. 62/976,019, filed on Feb. 13, 2020.

(51) Int. Cl. G06Q 40/08; G06Q 40/04; G06Q 40/02; G06Q 30/00

(52) U.S. Cl. CPC G06Q 40/08; G06Q 30/018; G06Q 40/025; G06Q 40/04

(57) ABSTRACT

A structured finance system, method and/or mechanisms presented herein provides proceeds to the receiver of a payment obligation with improved efficiency and certainty and substantially less burden associated with other attempted mechanisms. The systems, methods and/or mechanisms, may include a structured finance mechanism whereby the payer of a payment obligation undertakes a monetization transaction to distribute proceeds based on such payment obligation for the benefit of the receiver in a manner and based on a system which allows the receiver of such payment obligation to avoid, eliminate and/or minimize a majority of or substantially all of the costs, burdens and risks associated with a monetization transaction involving such payment obligation that otherwise typically are borne by the receiver.

### CROSS-REFERENCE TO RELATED APPLICATION

This application claims the benefit of U.S. Provisional Application No. 62/976,019, entitled STRUCTURED FINANCE MECHANISM, filed on Feb. 13, 2020, which is hereby incorporated by reference in its entirety.

### TECHNOLOGICAL FIELD

Example embodiments of the present disclosure relate generally to finance and, more particularly, to a structured finance mechanism to monetize payment obligations by the payer of a payment obligation to distribute proceeds based on such payment obligation to and for the benefit of the receiver of such payment obligation.

### BACKGROUND OF THE INVENTION

Traditionally, payment obligations have been monetized using finance mechanisms by which a receiver of a payment obligation either a) sells rights to such payment obligation, b) borrows money against such payment obligation, c) accepts investment proceeds or other value in exchange for direct or indirect participation in such payment obligation or d) enters into one or more agreements that combine aspects of one or more of the foregoing mechanisms. However, each of the foregoing mechanisms come with substantial downsides for a receiver of a payment obligation.

Indeed, all of the aforementioned traditional finance mechanisms can be tedious, costly, inefficient, and uncertain, in addition to having downsides specific to each mechanism. For example, the process of selling a right to a payment obligation by a receiver often requires the receiver of such payment obligation to incur significant upfront and ongoing out-of-pocket expenses, including but not limited to expenses for professional legal, tax, accounting, and financial advisory and underwriting assistance. In addition, the process of borrowing against a payment obligation by a receiver often requires a receiver of such payment obligation to incur significant, burdensome obligations of indebtedness, including but not limited to personal guaranties, collateral agreements, and/or other borrowing covenants, to secure timely payment of principal and interest of such borrowing. Lastly, the process of accepting investment proceeds relating to a payment obligation by a receiver also frequently requires a receiver of such payment obligation to accept lower proceeds and to forfeit control relating to such payment obligation.

Previous attempts have been made to improve finance mechanisms for monetizing payment obligations. These attempts have made use of features which include, but are not limited to, traditional credit, asset-backed securitization, private investment, insurance products and private credit. However, the previous attempts generally fail to meaningfully relieve the receiver of a payment obligation of the costs, burdens and risks described above.

Indeed, virtually all other attempted methods of monetizing a payment obligation require tedious and often uncompensated involvement of a receiver of such payment obligation. Moreover, such involvement is separate from and in addition to the negative aspects associated with negotiating a payment agreement, significant and uncertain total costs to be incurred by receiver of such payment obligation, and a significant and uncertain reduction in net proceeds available to receiver of such payment obligation. Consequently, there exists a need to create a system and mechanism that puts the receiver less at risk, reduces costs typically borne by the receiver and places the greater burden on the payer.

### BRIEF SUMMARY OF THE INVENTION

The present invention is directed to mechanisms, systems, and methods that, in one or more aspects, improves the cost, efficiency, and certainty of, and relieve burdens relating to, incurrence of obligations, loss of control, default, and other such burdens associated with other mechanisms used to monetize payment obligations. Additionally, in one or more aspects, the present invention provides a unique mechanism, system, and method by which a receiver of a payment obligation receives proceeds for such payment obligation without having to enter into a monetization transaction, and such that a majority of or substantially all of the costs and risks associated with such a monetization transaction are borne by the payer and not by the receiver.

In one embodiment, the structured finance mechanism system includes a payment agreement executed by a payer and receiver concerning a payment obligation between the payer and receiver. The system may also include an arranger engaged by the payer to design, advise, and supervise a monetization transaction. The system, through the involvement of the arranger or otherwise, may also incorporate additional third parties to facilitate the monetization transaction, including for example an Issuer SPE and investor. Based on the payment obligation, the Issuer SPE issues an additional monetization transaction, such as a structured note, to the investor in exchange for proceeds which are distributed, at least in part to the receiver. In additional embodiments, the system may also incorporate additional third parties including a trustee, a servicer, and a credit rating agency to facilitate the monetization transaction. The parties of the system carry out the system through networked terminal computers.

In various embodiments, the present system may be utilized in a variety of circumstances and potentially include additional terminals and parties. In separate embodiments, the system may be utilized in combinations involving one or multiple payers, with one or multiple receivers, and further involve additional mechanisms to avoid, eliminate, and minimize risks, excess costs, inefficiencies, uncertainties, timing discrepancies, incurrence of obligations, loss of control, default, and other burdens. For example, one or more of default protection and/or liability certificates, or credit enhancements, may be utilized in certain embodiments. Through utilization of the systems and methods herein, proceeds are distributed to a receiver from a payer with a majority of or substantially all of the risks, costs, inefficiencies, uncertainties, timing discrepancies, incurrence of obligations, loss of control, default, and other burdens being borne by the payer and not by the receiver.

Aside from the above circumstances, embodiments of the system and method may be utilized in a variety of other contexts. In one example, a multiplicity of payers presents various costs and uncertainties, including but not limited to the cost of administration of payments among payers and the uncertainty of payment by one or more payers, which may be effectively addressed via the disclosed systems, methods and/or mechanisms. In another example, variances in a payment obligation, including but not limited to variances in the timing of payments or variances in the values of payments, may be effectively addressed via the disclosed systems, methods and/or mechanisms.

In yet another example, differences in the type of payment of a payment obligation, including but not limited to pay-in-cash payments, payment-in-kind payments, and payments to one or more third parties, may be effectively addressed via the disclosed systems, methods and/or mechanisms. In a further example, a required upfront payment of a payment obligation presents numerous costs, inefficiencies, uncertainties, risks, and other burdens, including but not limited to the cost, uncertainty, and risk of reduction in proceeds and/or breach of payment obligation, may be effectively addressed via the disclosed systems, methods and/or mechanisms.

Moreover, variances in the payment obligation of one or more payers, including but not limited to an increasing or decreasing payment obligation based on changes in market conditions or the terms of a payment agreement, performance of payers and/or other such issues, presents uncertainties and risks which may be effectively addressed by the disclosed systems, methods and/or mechanisms. In another example, variances in the beneficiary interest of one or more receivers, including but not limited to increasing or decreasing beneficiary interests based on changes in market conditions, performance of receivers and or other such issues, presents uncertainties and risks which may be effectively addressed by the disclosed systems, methods and/or mechanisms. A further example provides variances in the number of payers and/or receivers participating in such a system over time, the timing of when one or more payers and/or one or more receivers begin to participate in such a system, the timing of when one or more payers and/or one or more receivers stop participating in such a system and/or other such issues, presents uncertainties and risks which may be effectively addressed by the disclosed systems, methods and/or mechanisms.

In another contextual example, the risk of negligent, willful, or other manner of default by a payer presenting a risk of breaching a payment agreement by which a payment obligation arises may be effectively addressed via the disclosed systems, methods and/or mechanisms. In a further example, the ability of one or more investors to invest more efficiently, at a lower cost of capital or in some other manner advantageous to the receiver due to the legal jurisdiction, tax status or other issues relating to such investors, including but not limited to investors such as insurance companies, domestic U.S. government entities, non-domestic sovereign institutions, offshore vehicles and other such potential investors, may be effectively addressed via the disclosed systems, methods and/or mechanisms.

### BRIEF DESCRIPTION OF THE DRAWINGS

These and other features, aspects, and advantages of the present invention will become better understood with regard to the following description, appended claims, and accompanying drawings where:

FIG. 1A is a system diagram of one embodiment of the system used to carry out a structured finance mechanism including, in particular, a monetization transaction between a single payer and a single receiver;

FIG. 1B is a system diagram of one embodiment of the monetization transaction of the system of 1A;

FIG. 2A is a system diagram of one embodiment of the system used to carry out a structured finance mechanism including, in particular, a monetization transaction between multiple payers and a single receiver;

FIG. 2B is a system diagram of one embodiment of the monetization transaction of the system of 2A;

FIG. 3A is a system diagram of one embodiment of the system used to carry out a structured finance mechanism including, in particular, a monetization transaction between a single payer and multiple receivers;

FIG. 3B is a system diagram of one embodiment of the monetization transaction of the system of 3A;

FIG. 4A is a system diagram of one embodiment of the system used to carry out a structured finance mechanism including, in particular, a monetization transaction between multiple payers and multiple receivers;

FIG. 4B is a system diagram of one embodiment of the monetization transaction of the system of 4A;

FIG. 5A is a system diagram of one embodiment of the system used to carry out a structured finance mechanism including, in particular, a liability certificate;

FIG. 5B is a system diagram of one embodiment of the monetization transaction of the system of 5A including, in particular, a liability certificate and default protection;

FIG. 6 is an exemplary timeline of a portion of a method for constructing a sample agreement in accordance with one embodiment of the structured finance mechanism system;

FIG. 7 is an exemplary timeline of a portion of a method regarding functions of a payer in accordance with one embodiment of the structured finance mechanism system;

FIG. 8 is an exemplary timeline of a portion of a method regarding functions of an arranger in accordance with one embodiment of the structured finance mechanism system;

FIG. 9 is an exemplary timeline of a portion of a method regarding functions of an aggregation vehicle in accordance with one embodiment of the structured finance mechanism system;

FIG. 10 is an exemplary timeline of a portion of a method regarding additional functions of an aggregation vehicle in accordance with one embodiment of the structured finance mechanism system;

FIG. 11 is an exemplary timeline of a portion of a method regarding functions of an Issuer SPE in accordance with one embodiment of the structured finance mechanism system;

FIG. 12 is an exemplary timeline of a portion of a method regarding additional functions of an Issuer SPE in accordance with one embodiment of the structured finance mechanism system;

FIG. 13A is a flow chart of one embodiment of a part of a structured finance mechanism method associated in accordance with this disclosure;

FIG. 13B is a flow chart of one embodiment of a part of a structured finance mechanism method associated in accordance with this disclosure continued from FIG. 13A; and

FIG. 13C is a flow chart of one embodiment of a part of a structured finance mechanism method associated in accordance with this disclosure continued from FIG. 13B.

### DETAILED DESCRIPTION OF THE INVENTION

### Definitions and Interpretations

To better understand the following invention, please note the following definitions and interpretations used in this description:

The term “Aggregation Vehicle” herein is used to mean a special purpose entity or system component meant to aggregate and administer payments from payers in connection with a monetization transaction.

The term “Allocation Vehicle” herein is used to mean a special purpose entity or system component meant to receive payment from proceeds of a monetization transaction for distribution to receivers.

The term “Arranger” herein is used to mean the party or system component whose role shall be designing and implementing structured solutions embodied herein, administering payments from payer, arranging default protection, supervising legal, tax, financial advisory and broker-dealer relationships and activities and coordinating other such financial apparatuses, methods and/or mechanisms in connection with a monetization transaction.

The term “comprises,” and grammatical equivalents thereof, are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

The term “Default Protection” herein is used to mean a contract, option, security, insurance product or other financial instruments by which one or more parties provide protection against default for the benefit of one or more third parties and agree to make defined payment(s) contingent upon an event of default in exchange for receipt of premium payments.

The term “Credit Enhancement” herein is used to mean one or more apparatuses, methods and/or mechanisms used to create a finance solution, including but not limited to a reserve fund, default protection, insurance and other such apparatuses, methods and/or mechanisms, whose purpose is to enhance the credit worthiness of a structured note or other form of indebtedness that is a part of a monetization transaction by securing and/or guarantying partially or completely the timely payment of principal and interest in connection with such structured notes or other monetization transaction.

The term “Default” herein is used to mean any act or omission of a payer or other party or any circumstance that leads to non-payment of a payment obligation, the status of non-payment of a payment obligation and any decline in the credit worthiness or credit rating of a payer or other party regarding any payment obligation.

The term “Example” herein is used to mean “serving as an example, instance or illustration.” Any implementation described herein as “example” is not necessarily to be construed as preferred or advantageous over other implementations.

The term “Investor” herein is used to mean a provider of economic capital or other form of value in exchange for economic or other participation, which may include but may not be limited to principal and interest, in a payment obligation according to the terms of a structured note or other monetization transaction.

The term “Issuer SPE” herein is used to mean a special purpose entity or system component whose role will be to issue notes to qualified investors based on third-party underwriting, legal opinion(s), and credit rating(s) of assigned payment obligations, legal structure, default and other analysis, credit enhancements and operating and servicing risks as part of a monetization transaction.

The term “Liability Certificate” herein is used to mean a finance apparatus, method and/or mechanism through which the right of recourse for breach of a legal obligation related to a payment agreement may be separated from the right of recourse for breach of timely payment of principal and interest of a monetization transaction backed by payments arising as a result of such payment agreement so that such liability certificate may be assigned, either in whole or in part, and either exclusively or non-exclusively, to a third-party separately from a structured note or other form of indebtedness that may be a part of a monetization transaction and may be acted upon independently of such monetization transaction.

The term “Monetization” and “Monetization Transaction” herein is used to mean the conversion of a right to a payment obligation into cash, cash equivalency or other desired form of value by the use or application of borrowing, structured note, underwriting, annuitization, lump-sum payout, settlement or other form or combination of indebtedness, financing, insurance or risk management apparatuses, methods and/or mechanisms.

The term “Moral Hazard” herein is used to mean the risk of negligent, willful, or other manner of default by one or more payers to make payments required by a payment agreement once the proceeds of a structured note or other form of monetization transaction backed by such party's payment obligation have been paid to the receiver.

The term “Payer” herein is used to mean a party who is obligated to make one or more payments in cash, cash equivalents or some other form of value as a part of a payment obligation.

The term “Receiver” herein is used to mean a party who has the right to receive one or more payments in cash, cash equivalents or some other form of value as a part of a payment obligation.

The term “Reserve Fund” herein is used to mean a financial mechanism for providing credit enhancement as part of a monetization transaction by reserving an amount of money from a payment obligation to support and, if necessary, pay for the timely payment of principal and interest and/or other obligations of an issuer SPE.

The term “Servicer” herein is used to mean a third-party entity or system component whose role will be to keep physical custody of completed documentation, calculate cash flows, calculate any default impact, and provide standardized reporting for use by issuer SPE, issuer SPE trustee and others as part of a monetization transaction.

The term “Structured” herein is used to mean the use or application of finance, insurance and/or risk management apparatuses, methods and/or mechanisms to define the roles, relationships, rights and/or obligations among counterparties to a financial obligation such as a payment obligation.

The term “Structured Notes” herein is used to mean a written instrument of indebtedness, financing, insurance, risk management or other monetization transaction which describes the terms by which an investor may obtain economic participation, which may include but may not be limited to principal and interest, in a payment obligation.

The term “Payment Obligation” herein is used to mean a series of payment obligations required by a payment agreement that defines the timing, amount and type of payment, the payer and receiver of such payments and other terms and conditions governing such payments.

The term “Payment Agreement” herein is used to mean an agreement, contract, court order, settlement, or other such mechanism under which a payment obligation arises.

The term “Trustee” herein is used to mean a third-party entity or system component whose role will be to receive and disburse cash on behalf of the issuer SPE, hold and administer reserve funds, exercise default protection in any event of default, provide notification by electronic notification or other means of any event of default to investors and others and provide standardized reporting to investors and others as part of a monetization transaction.

For the purposes of this disclosure, the following terminals shall be considered to be owned, administered, or operated by the following parties:

| Terminal | Party |
|---|---|
| Aggregation Terminal | Aggregation Vehicle |
| Allocation Terminal | Allocation Vehicle |
| Arranger Terminal | Arranger |
| Credit Rating Agency Terminal | Credit Rating Agency |
| Investor Terminal | Investor |
| Monetization Terminal | Issuer SPE |
| Payer Terminal | Payer |
| Receiver Terminal | Receiver |
| Servicer Terminal | Servicer |
| Trustee Terminal | Trustee |

Unless otherwise implied or indicated, it is noted that, statements and limitations involving a particular terminal may also be taken to mean that they involve the parties that the terminal is owned, administered, or operated by. Thereby, a statement that an agreement has a payer terminal and receiver terminal as parties thereto may be taken to also mean the payer and receiver are parties to the agreement.

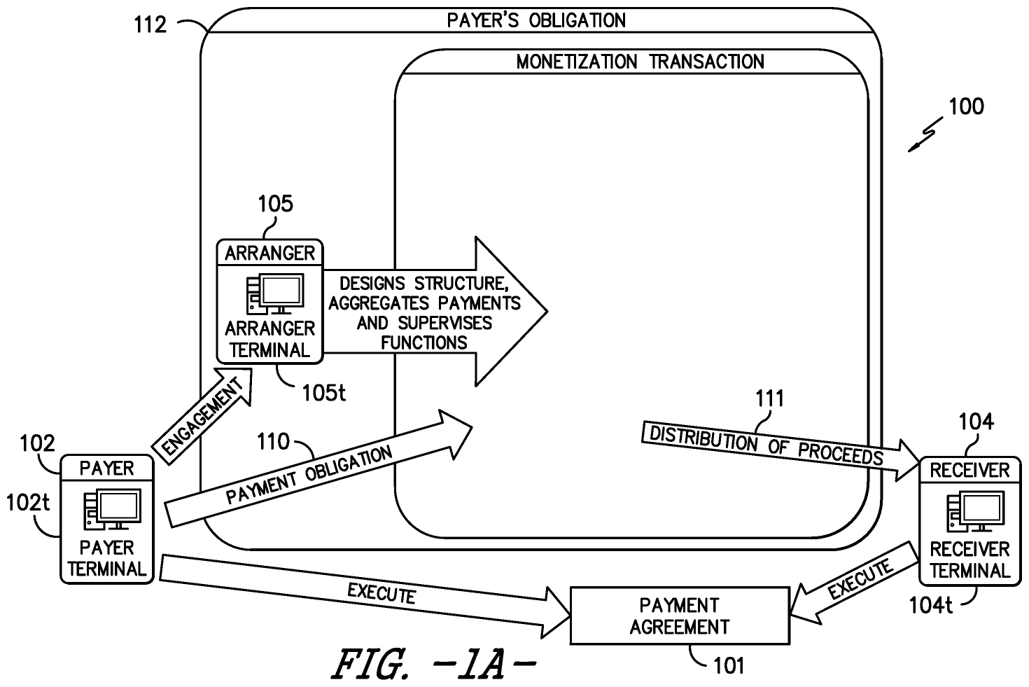

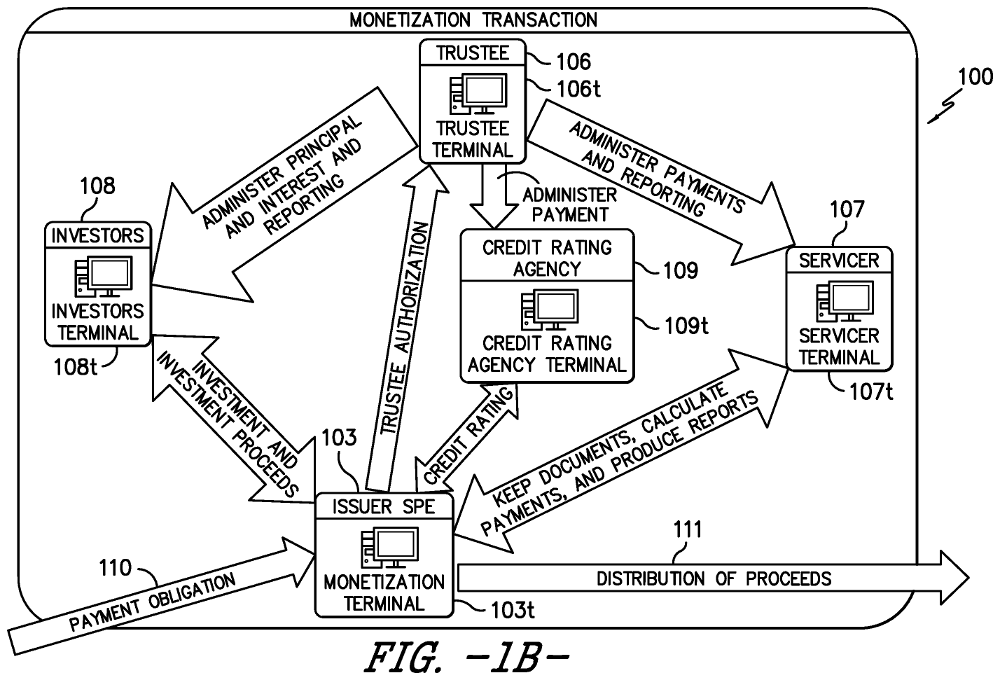

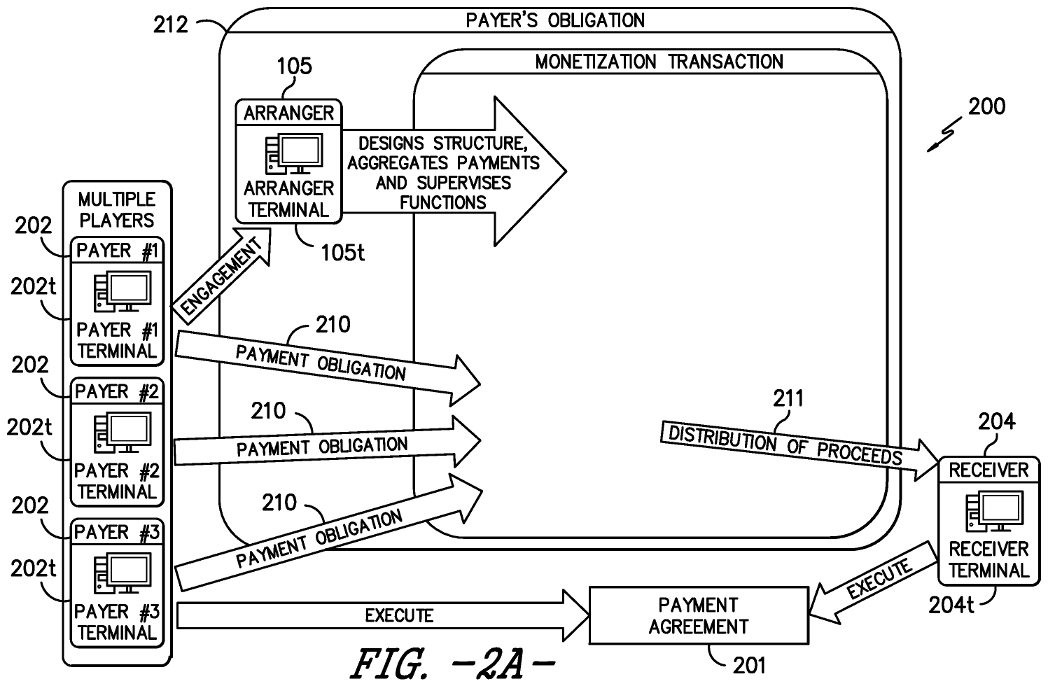

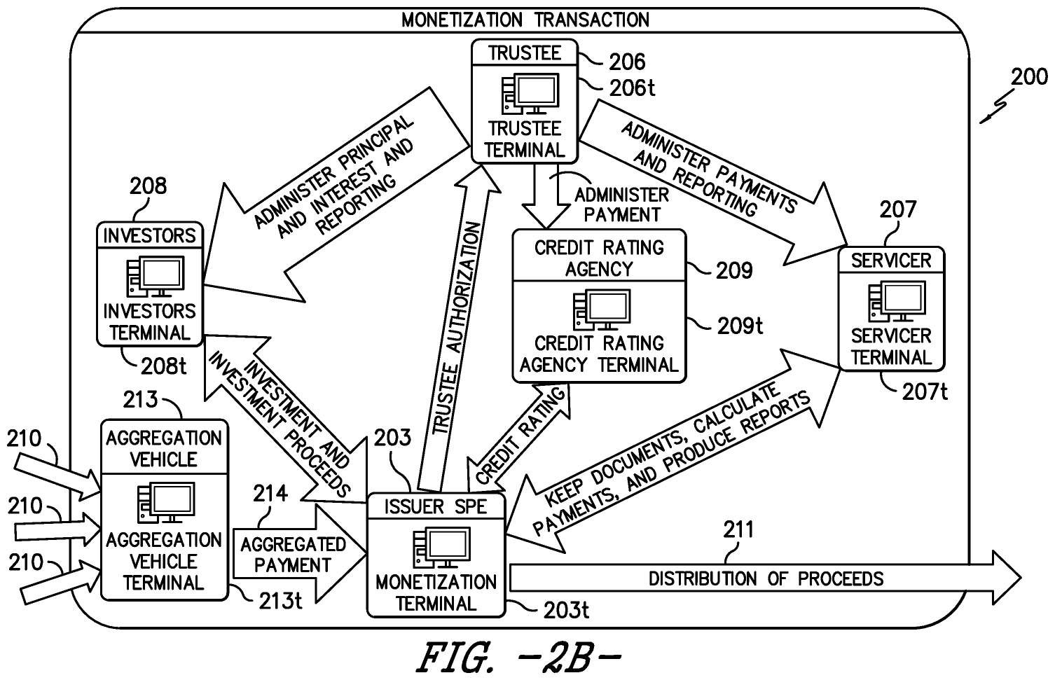

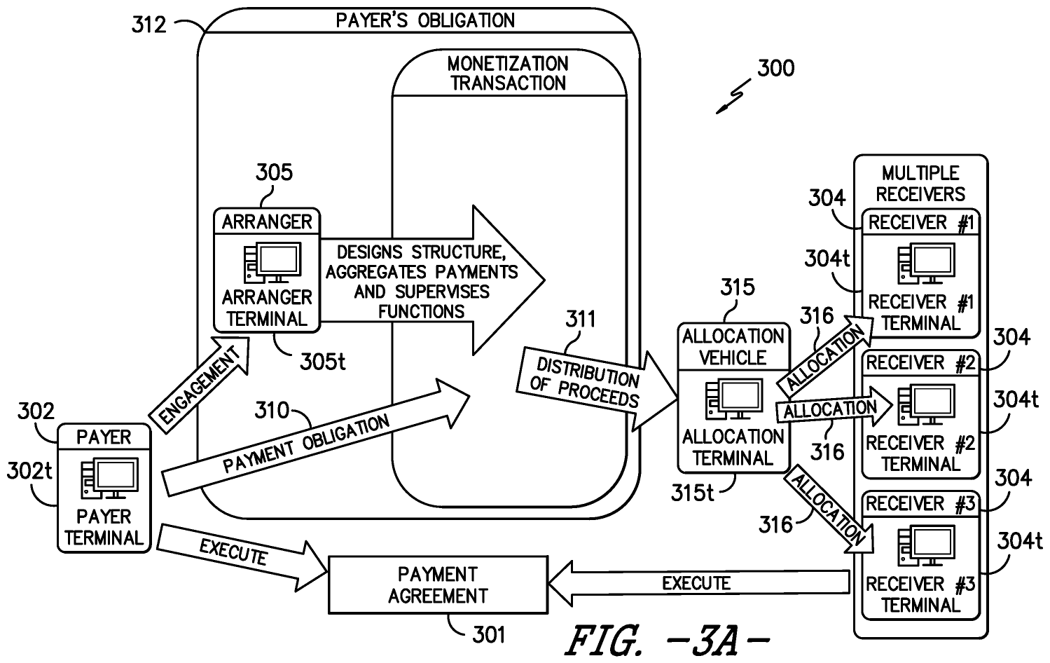

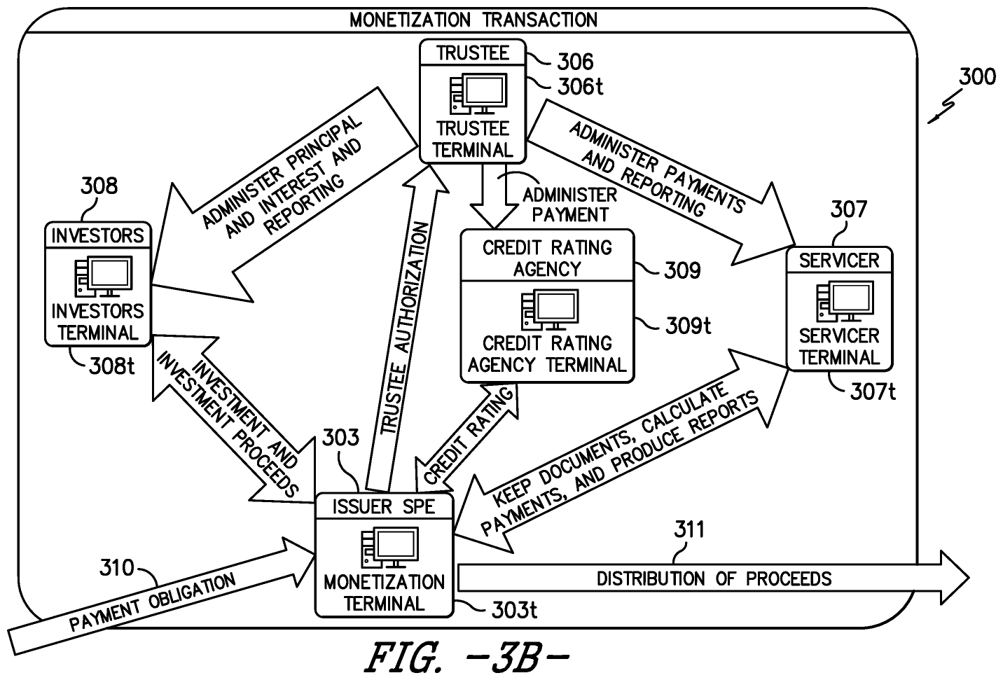

Moreover, it is noted that for convenience in discussion of various figures and embodiments, similar elements may have different but similar numbers to represent them. For example, payer in FIG. 1 is labeled 102 and in FIG. 2 is labeled 202 and in FIG. 3 is labeled 303. Accordingly, any like numbers should be construed to refer to like elements throughout.

Further, diagrammatic shapes used in illustrations contained herein are meant to show generally counterparties to an embodiment and connecting lines between such counterparties are meant to illustrate generally the relationship among and between such counterparties. These diagrammatic shapes and connecting lines are not meant to be limiting, or comprehensively descriptive, in illustrating the number, type or role of counterparties or the relationship among counterparties.

Please note, although the present invention will be described in considerable detail with possible reference to certain preferred versions thereof, other versions are possible. Therefore, the spirit and scope of the appended claims should not be limited to the description of the preferred versions contained herein. All features disclosed in this specification may be replaced by alternative features serving the same, equivalent, or similar purpose, unless expressly stated otherwise. Thus, unless expressly stated otherwise, each feature disclosed is one example only of a generic series of equivalent or similar features. Further, it is not necessary for all embodiments of the invention to have all the advantages of the invention or fulfill all the purposes of the invention.

In the present description, the claims below, and in the accompanying drawings, reference is made to particular features of the invention. It is to be understood that the disclosure of the invention in this specification is illustrative for purposes of description only and does not include all possible combinations of such particular features. For example, where a particular feature is disclosed in the context of a claim, that feature can also be employed, to the extent possible, in aspects and embodiments of the invention, and in the invention generally.

Also, although the description above contains many specificities, these should not be construed as limiting the scope of the embodiments but as merely providing illustrations of some of several embodiments. Thus, the scope of the embodiments should be determined by the appended claims and their legal equivalents, rather than by the examples given.

Lastly, singular and plural versions of similar terms should be considered as synonymous.

### Invention Description

The present invention now will be described more fully hereinafter with reference to the accompanying drawings in which some but not all embodiments of the invention are shown. Indeed, this invention may be embodied in many different forms and should not be construed as limited to the embodiments set forth herein; rather these embodiments are provided so that this disclosure will satisfy applicable legal requirements.

With reference to FIGS. 1A and 1B, the diagram illustrates a system 100 carrying out a monetization transaction in which a payment obligation 110 is monetized by a single payer 102 and paid to a single receiver 104. The diagram includes a system 100 comprising one or more terminals utilized to carry out multiple functions related to a monetization transaction process. Specifically, once one or more payment agreements 101 are executed by payer terminal 102t and receiver terminal 104t, payer 102 may undertake a monetization transaction by which a payment obligation 110 of payer 102 may be monetized and the proceeds of such monetization may be paid to receiver 104 via receiver terminal 104t. Once a payment agreement 101 is established, the process of monetization may occur. To facilitate a monetization transaction, an arranger 105 utilizes an arranger terminal 105t to design structured finance solutions, aggregate payments by payer 102, supervise transfer of funds (input including at least one payment obligation 110) to an issuer SPE 103 through a monetization terminal 103t and supervise roles and functions of third-parties working to effect a monetization transaction, including, but not limited to legal, tax and financial advisors, underwriters, etc. In certain embodiments, payments associated with the payment obligation 110 from payer terminal 102t may or may not be due to receiver 104 in equal increments over a period of time.

In embodiments, the arranger terminal 105t may design, encode, cause to be produced and/or supervise computer readable code housed on and/or distributed by, through, as instructed by, as recorded by and/or as stored on memory of a network server, computer and/or computer system owned and/or controlled by the arranger terminal 105 and/or the aggregation terminal 213t (reference to FIG. 2), which code contains processes, methodologies and instructions for calculating, receiving, aggregating, transferring, distributing and/or confirming of payments related to the monetization transaction.

Within the confines of the monetization transaction process, and via the system, arranger 105 may interface with other third parties necessary or desirable for a monetization transaction, including, but not limited to an issuer SPE 103 utilizing a monetization terminal 103t, a trustee 106 utilizing a trustee terminal 106t, a servicer 107 utilizing a servicer terminal 107t, one or more investors 108 each utilizing an investor terminal 108t and one or more credit rating agencies 109 each utilizing a credit rating terminal 109t.

Issuer SPE 103/monetization terminal 103t via the system may function as a bankruptcy remote vehicle that may issue structured notes or other monetization transaction to investor terminal 108t backed by the payment obligation of payer 102, receive investment proceeds from investor terminal 108t, distribute proceeds 111 to receiver terminal 104t and communicate standard reporting information to investor terminal 108 and other third-parties; this information may be stored on a memory of the monetization terminal 103t.

Trustee terminal 106t via the system may act as an independent agent of issuer SPE 103. Trustee terminal 106t via the system 100 may administer principal and interest to one or more investor terminals 108t, administer payments to one or more service providers such as servicer terminal 107t, credit ratings terminal 109t and others and administer reserve funds that may be a part of a monetization transaction; this information may be stored on a memory of trustee terminal 106t.

Servicer terminal 107t via the system 100 may calculate payment of principal and interest, identify any event of default, calculate any default impact, store transaction documentation in a memory of servicer terminal 107t, confirm receipt payment obligations 110 from payer terminal 102t and provide standard reporting information to trustee terminal 106t and other third-party terminals; this information may be stored on a memory of servicer terminal 107t.

Investor terminal 108t via the system 100 may invest in structured notes or other monetization transaction, providing investment proceeds to monetization terminal 103t (or its assigns or designees), receive administrations of principal and interest from trustee terminal 106t and receive standard reporting information from trustee terminal 106t; this information may be stored on a memory of investor terminal 108t.

Credit rating agency terminal 109t may assess the credit worthiness and other aspects of the structured note or other form of indebtedness as a part of a monetization transaction and may assign one or more credit ratings to such structured notes or other monetization transaction that may be used by underwriters and investors to help to establish a market price for the structured note or other monetization transaction; this information may be stored on a memory of credit rating terminal 109t.

Payer's Obligation Box 112 illustrates that substantially all elements of a monetization transaction in the disclosed systems, methods and/or mechanisms are undertaken by payer 102 (being located within the Box 112) and not by receiver 104 (being located outside the Box 112) indicating that substantially all costs and risks of such monetization transaction are borne by payer 102 and not by receiver 104.

It is noted that any data flow/transfer may be carried out within a network that connects the aforementioned terminals.

It is noted that a third-party terminal may comprise any of a monetization terminal 103t, a trustee terminal 106t, a servicer terminal 107t, a credit rating agency terminal 109t, an investor terminal 108t and an arranger terminal 105t and/or aggregation terminal 213t. Monetization terminal 103t may be configured to receive input from any of the other third-party terminals. While a servicer terminal 107t, a trustee terminal 106t, and a credit rating agency terminal 109t are shown in FIG. 1, it is foreseen in this and later embodiment that one or more of these and other terminals may be excluded if another party/terminal. For example, if an investor terminal 108t, performs the necessary acts associated with another terminal, the other terminal may be excluded for the monetization transaction.

With reference to FIGS. 2A and 2B, the diagram illustrates a system 200 carrying out a monetization transaction in which a payment obligation 210 is monetized by a multiplicity of payers 202 and paid to a single receiver 204. Elements of the prior embodiment illustrated by FIGS. 1A and 1B that are generally applicable to the embodiment found in FIGS. 2A and 2B are incorporated herein by reference as equally descriptive of the present embodiment. In this embodiment, payer 202 is comprised of more than one payer, demonstrated in this example as “Payer #1,” “Payer #2” and “Payer #3”, such that more than one payer is obligated under one or more payment agreements 201 to make payments to receiver 204. Payment obligations 210 of the payers 202 may or may not be equivalent among the payers 202 for purposes of the present embodiment. Arranger terminal 205t may cause an aggregation vehicle 213 utilizing an aggregation terminal 213t to be formed/created and to be supervised by arranger 205 in order to aggregate payment obligations 210 received from each payer 202 and to transfer an aggregated payment 214 to issuer SPE 203 utilizing a monetization terminal 203t (or its assigns or designees). Transfer of the aggregated payment 214 to monetization terminal 203t may or may not be executed in regular periodic payments for purposes of the present embodiment depending on the terms and conditions contained in a payment agreement 201.

It is noted that other functions described in previous embodiments remain the same. The systems, methods and/or mechanisms indicated in the previous embodiment may be equally applicable in the present embodiment as indicated by the Payer's Obligation Box 212, which illustrates that substantially all elements of a monetization transaction under the present embodiment are undertaken by payers 202 and not by a receiver 204 such that substantially all costs and risks of the monetization transaction may be borne by payers 202 and not by a receiver 204.

With reference to FIGS. 3A and 3B, the diagram illustrates a system 300 carrying out a monetization transaction in which a payment obligation 310 is monetized by a single payer 302 and paid to more than one receiver 304, demonstrated in this example as “Receiver #1,” “Receiver #2,” and “Receiver #3.” Elements of prior embodiments illustrated by FIGS. 1A, 1B, 2A, and 2B that are generally applicable to the present embodiment are incorporated herein by reference as equally descriptive of the present embodiment. In the present embodiment, a single payer 302 is obligated to make payments to receivers 304 under one or more payment agreements 301 to make payments to receivers 304. The payments to be received by each individual receiver 304 may or may not be equivalent among such receivers 304 for purposes of the present embodiment. To facilitate a monetization transaction, an arranger 305 utilizes an arranger terminal 305t to design solutions, aggregate payment obligations 210 received from payer 302 and transfer such funds based on such payment obligations 210 to an issuer SPE 303 through a monetization terminal 303t. Issuer SPE 303 through a monetization terminal 303t issues structured notes or other monetization transaction to investors 308 and the proceeds received from investors 308 are distributed to receivers 304. Receivers 304 may cause an allocation vehicle 315 to be formed/created to bear sole responsibility for receiving and allocating proceeds distributed 311 by issuer SPE 303 utilizing a monetization terminal 303t (or its assigns or designees). Other functions described in prior embodiments remain the same. The system, method and/or mechanism indicated in prior embodiments is equally applicable in the present embodiment as indicated by Payer's Obligation Box 312, which illustrates that substantially all elements of a monetization transaction under the present embodiment are undertaken by payer 302 and not by receivers 304 such that substantially all costs and risks of such monetization transaction are borne by payer 302 and not by receivers 304.

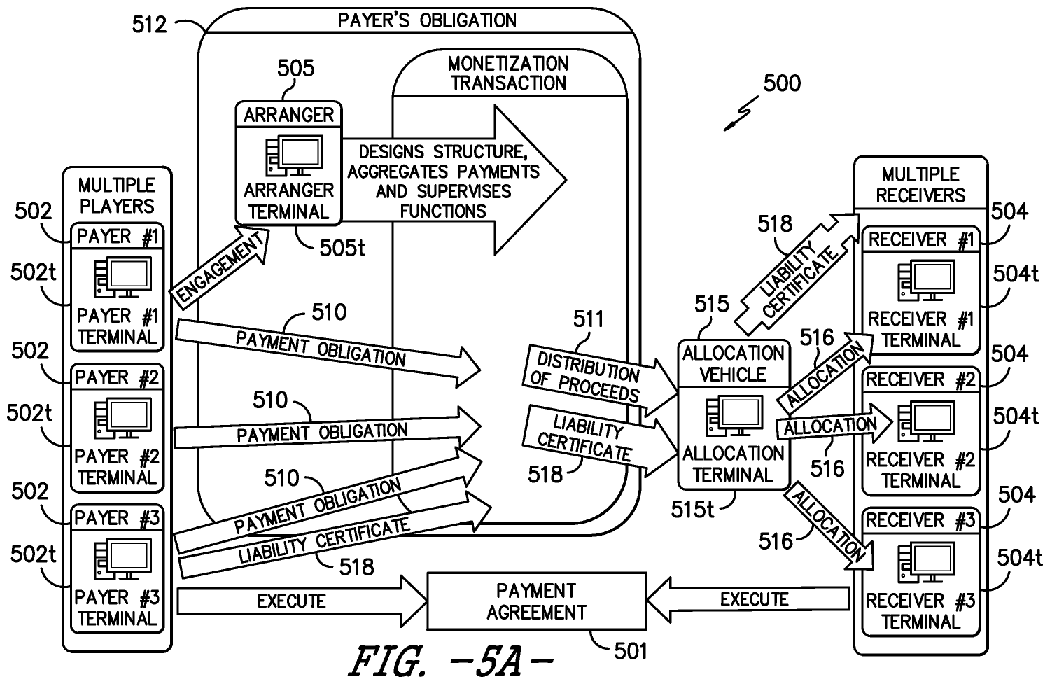

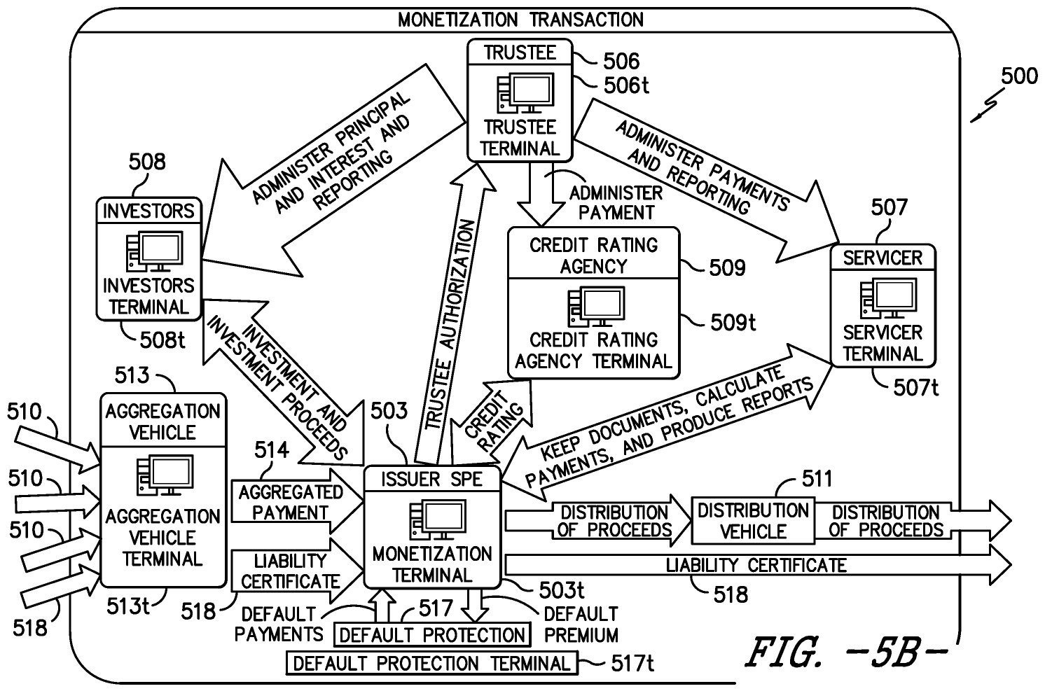

In embodiments, the more than one receiver terminal 304t and/or the at least one allocation terminal 315t may not be a party to and may be excluded from all steps of the monetization transaction except for a) the execution of at least one payment agreement 301, b) the receipt and allocation of the at least one proceeds distributed 311 based on the monetization transaction described herein and, if applicable, c) the receipt of at least one liability certificate 518 described below and shown in the embodiment illustrated by FIGS. 5A and 5B.

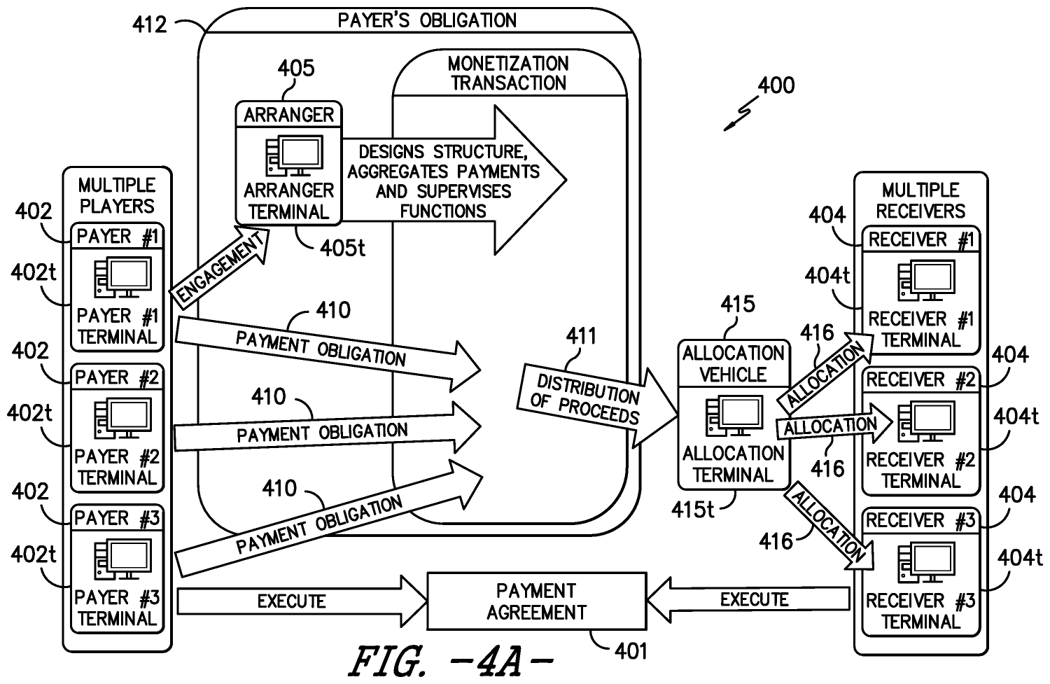

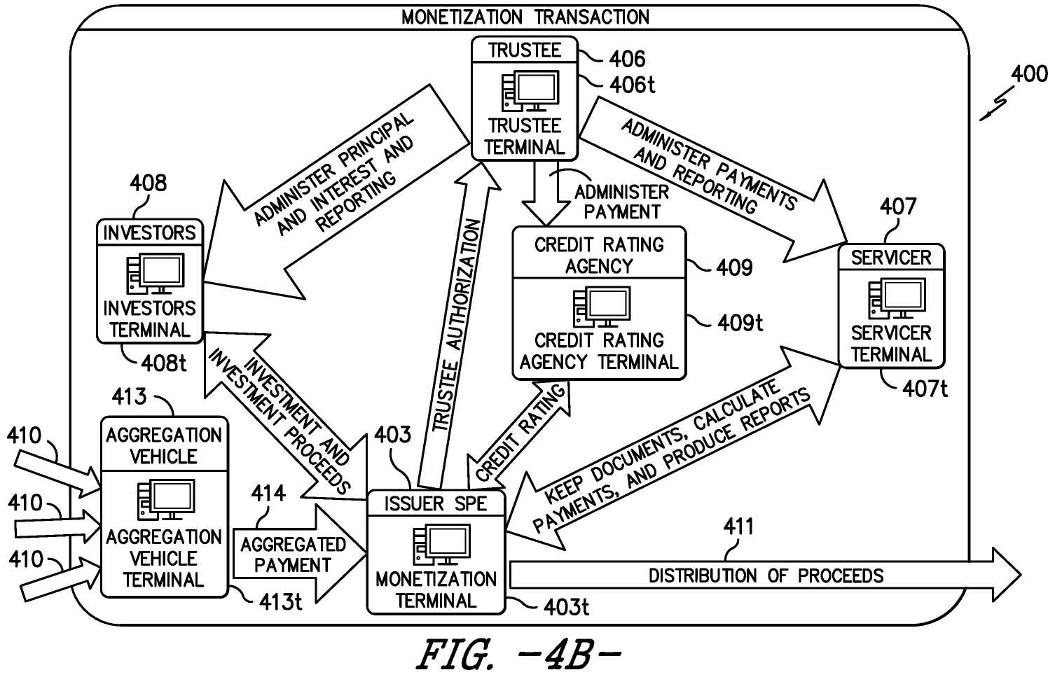

With reference to FIGS. 4A and 4B, the diagram illustrates a system 400 carrying out a monetization transaction in which a payment obligation 410 is monetized by payers 402 and paid to receivers 404. Elements of prior embodiments illustrated by FIGS. 1A, 1B, 2A, 2B, 3A, and 3B that are generally applicable to the embodiment found in FIGS. 4A and 4B are incorporated herein by reference as equally descriptive of the present embodiment. In this embodiment, a multiplicity of payers 402 is obligated to make payments to a multiplicity of receivers 404 under one or more payment agreements 401. Aggregation vehicle 413 and associated terminal 413t may be utilized by or on behalf of payers 402 to aggregate individual payments from payers 402 and to transfer such funds to issuer SPE 403 utilizing a monetization terminal 403t. An allocation vehicle 415 may be utilized by receivers 404 to receive proceeds distributed 411 based on a monetization transaction and allocate such payment among individual receivers 404. Other functions described in prior embodiments remain the same. The system, method and/or mechanism indicated in prior embodiments is equally applicable in the present embodiment as indicated by the Payer's Obligation Box 412, which illustrates that substantially all elements of a monetization transaction under the present embodiment are undertaken by payers 402 and not by receivers 404 such that substantially all costs and risks of such monetization transaction are borne by payers 402 and not by receivers 404.

With reference to FIGS. 5A and 5B, the diagram illustrates a system 500 carrying out a monetization transaction in which one or more payers 502 make payment obligations 510 which are aggregated and transferred by an aggregation vehicle 513 and/or arranger 505 to an issuer SPE 503 using a monetization terminal 503t to issue structured notes or other monetization transaction to investors 508 and to distribute the proceeds of such structured notes or other monetization transaction and/or payment obligations 510, or some combination or derivative of such payments, via a distribution vehicle 511 to an allocation vehicle 515 and/or one or more receivers 504, and includes systems, methods and/or mechanisms to avoid, eliminate and/or minimize the costs, inefficiencies, uncertainties, incurrence of obligations, loss of control, default and other such burdens of a monetization transaction on the receiver 504. In connection with such systems, methods and/or mechanisms, arranger 505 may cause distribution vehicle 511 to be formed/created and to be supervised by arranger 505 in order to manage and distribute the proceeds of a monetization transaction. Such systems, methods and/or mechanisms are equally applicable to and are included by reference in prior embodiments illustrated in FIGS. 1A, 1B, 2A, 2B, 3A, 3B, 4A, and 4B. The present embodiment contemplates risk protection systems, methods and/or mechanisms including and not limited to default protection and/or credit enhancement involving a multiplicity of payers 502, default protection 517 involving one or more individual payers 502 and further protection involving a liability certificate 518. Arranger 505 may design, advise on, and supervise such credit enhancement and default protection systems, methods and/or mechanisms in conjunction with various third parties (see previously mentioned third-parties) such as legal, tax and financial counsel, underwriters, credit ratings agencies, investors, and others.

With further reference to FIGS. 5A and 5B, the distribution via the issuer SPE 503 using a monetization terminal 503t and/or the distribution vehicle 511 of the structured finance mechanism 500 may include, but is not limited to, proceeds from the issuance of structured notes or other monetization transaction to investors 508, payment of payment obligations 510 or some combination or derivative of such payment sources. The distribution vehicle 511 may manage the proceeds of a monetization transaction prior to and/or in connection with distributing such payment sources to receivers 504 and/or the allocation vehicle 515. The distribution of such payment sources may be made directly to the allocation vehicle 515, directly to one or more receivers 504 and/or some combination of derivative or such parties.

With further reference to FIGS. 5A and 5B, default protection 517 involving payers 502 protects against default of the payers 502 that threatens the timely payment of principal and interest and other obligations of issuer SPE 503, using a monetization terminal 503t. Default protection 517 involving one or more individual payers 502 protects against default of one or more individual payers 502 that threatens performance of other individual payers 502 and/or the timely payment of principal and interest and other obligations of issuer SPE 503 using a monetization terminal 503t. Similarly, default protection 517 may alternatively be represented by credit enhancement systems or methods. Such default protection or credit enhancement may be achieved in part or in whole by means of credit default contracts, insurance instruments, options contracts and/or other such financial instruments.

In embodiments, at least one of the third-party terminals may provide credit enhancement or protection against default of payment obligations 510 and/or other obligations by a plurality of the at least one payer terminal 502t on a collective basis and not on an individual basis by utilizing at least one of, or a combination of, a credit default contract, an option contract, an insurance product and/or another default protection or credit enhancement instrument.

In embodiments, at least one third party terminal may provide credit enhancement or protection against default of payment obligations 510 and/or other obligations by the at least one payer terminal 502t on an individual basis and not on a collective basis by utilizing at least one of, or a combination of, a credit default contract, an option contract, an insurance product and/or another default protection or credit enhancement instrument.

With further reference to FIGS. 5A and 5B, credit enhancement or default protection involving a liability certificate 518 protects against one or more payers willfully, negligently, or otherwise defaulting on payment obligations 510 once the proceeds of a monetization transaction have been paid to receivers 502. A liability certificate 518 is a financial mechanism through which the right of recourse for breach of a legal obligation related to a payment agreement 501 is separated from the right of recourse for breach of timely payment to the issuer SPE 503, using monetization terminal 503t, for purposes of paying principal and interest on a structured note or other monetization transaction backed by payments arising as a result of such payment agreement 501. The liability certificate 518 may be assigned separately to a third-party (such as those listed in the above paragraphs), which is not an investor in the structured note or other monetization transaction and may be acted upon independently of such structured note or other monetization transaction.

With further reference to FIGS. 5A and 5B, the systems, methods and/or mechanisms indicated in previously disclosed embodiments are equally applicable in the present embodiment, for example, as indicated by the Payer's Obligation Box 512. The liability certificate 518 in the present embodiment is a separate system, method and/or mechanism which is an independent element of the disclosure.

With further reference to FIGS. 5A and 5B, due to the disclosed systems, methods and/or mechanisms, including and not limited to the liability certificate 518, substantially all of the elements of a monetization transaction may be undertaken by payers 502 and not by receivers 504 and substantially all of the costs and risks of such a monetization transaction may be borne by payers 502 and not by receivers 504.

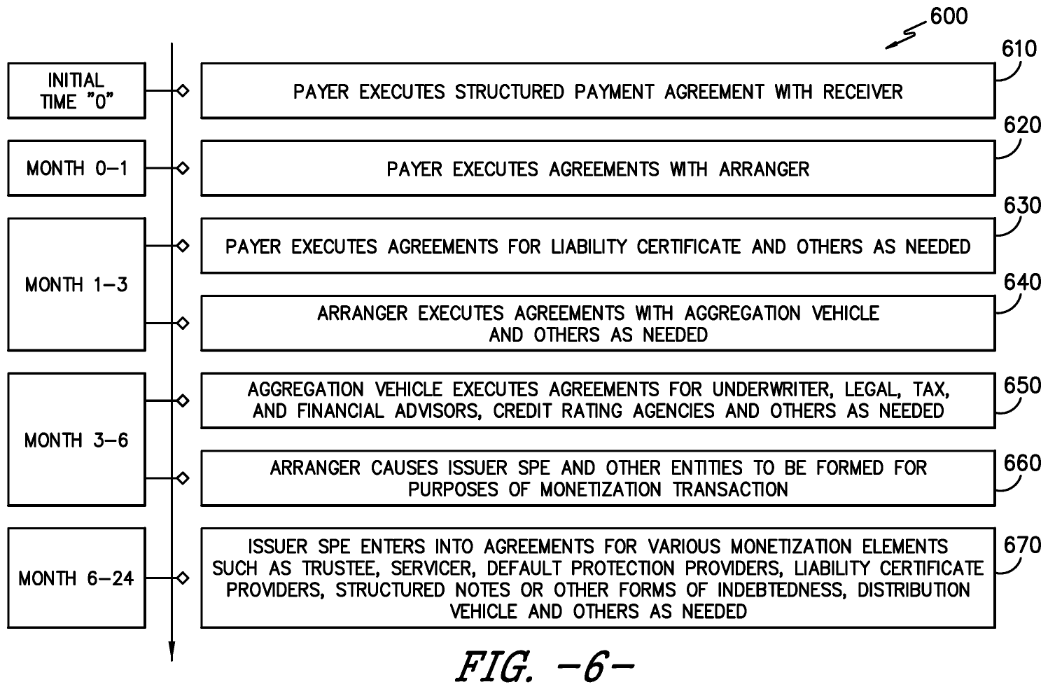

FIG. 6 illustrates a timeline 600 for constructing a sample agreement in accordance with embodiments. Timeline 600 may include executing 610 a payment agreement 101 between one or more payers 102 and one or more receivers 104. The payer terminal 102t and receiver terminal 104t may execute and send computer readable code representative of the agreement 101 to one another over a network until the agreement 101 is confirmed and agreed upon by both sides. The code representative of the agreement 101 may be stored on a memory associated with each of the payer terminal 102t and the receiver terminal 104t. Payer 102 may then execute 620 an agreement with arranger 105. The payer terminal 102t and arranger terminals 105t may execute and send computer readable code representative of an agreement to one another over a network until the agreement is confirmed and agreed upon by both sides. The code representative of the agreement may be stored on a memory associated with each of the payer terminal 102t and the arranger terminal 105t. Once complete, payer 102 may then execute 630 agreements for a liability certificate 518 and others as needed and execute 640 agreements with an aggregation vehicle 213 and others as needed. To carry out steps 630 and 640, payer terminal 102t and monetization terminal 103t and aggregation terminal 213t may execute and send computer readable code representative of agreements to one another over a network until the agreements are confirmed and agreed upon by both sides. The code representative of the agreement may be stored on a memory associated with each of the payer terminal 102t, the monetization terminal 103t and arranger terminal 105t. As a result of execution step 640, aggregation vehicle 213 may execute 650 agreements for underwriters, legal, tax and financial advisors, credit rating agencies and other third parties. Aggregation terminal 213t and third-party terminals may execute and send computer readable code representative of agreements to one another over a network until the agreements are confirmed and agreed upon by both sides. The code representative of the agreement may be stored on a memory associated with each of the aggregation terminal 213t and the third-party terminals.

After the above contracts are in place, arranger 105 may cause issuer SPE 103 through monetization terminal 103t to be formed/created 660 for the purposes of monetizing one or more transactions stemming from payer 102. Issuer SPE 103 may then enter 670 into agreements for various monetization elements such as trustee 106, servicer 107, default protection 517 providers, liability certificate 518 providers, structured notes or other monetization transaction, distribution vehicle and others as needed.

It is noted that specific steps in timeline 600 may occur at different times, an example of which is shown in FIG. 6. Step 610 may occur at a time “0”. Step 620 may occur from 0 to 1 months after step 610 for example. Step 630 may occur from 1 to 3 months after step 610 for example. Step 640 may occur from 1 to 3 months after step 610 for example. Step 650 may occur from 3 to 6 months after step 610 for example. Step 660 may occur from 3 to 6 months after step 610 for example. Step 670 may occur from 6 to 24 months after step 610 for example.

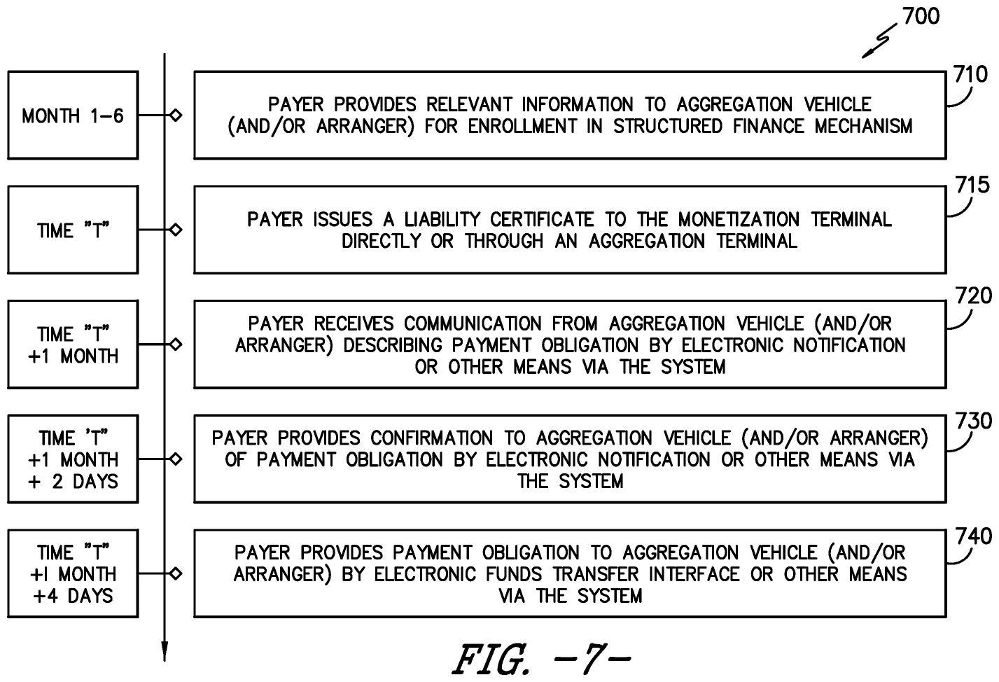

FIG. 7 illustrates a timeline 700 depicting functions of a payer 102 in accordance with embodiments. Payer 102 may provide 710 relevant information to aggregation vehicle 213 and/or to arranger 105 for enrollment in a structured finance mechanism system 100 (see FIGS. 1A-5B). A payer may also issue 715 a liability certificate 518 to the issuer SPE 103 and monetization terminal 103t directly or through an aggregation vehicle 213 or other component of the system. Once enrolled in the structured finance system 100, payer 102 may then receive 720 communication from aggregation vehicle 213 and/or arranger 105 that describes payment obligation by electronic notification or other means via the system 100. At this point, payer 102 may provide 730 confirmation to aggregation vehicle 213 and/or to arranger 105 of payment obligation 110 by electronic notification or other means via the system 100. Payer 102 may then provide 740 payment obligation 110 to aggregation vehicle 213 (and/or arranger 105) by an electronic funds transfer interface or by other means via the system 100.

It is noted that specific steps in timeline 700 may occur at different times, an example of which is shown in FIG. 7. Step 710 may occur at a time between 1 and 6 months for example. Step 715 may occur at the time of a monetization transaction closing, labeled as Time “T”. Time T is often considered to be the 24-month mark. Step 720 may occur during 1 month after the 24-month mark of step 670 for example. Step 730 may occur up to 2 days after step 720 for example. Step 740 may occur up to 2 days after step 730 for example.

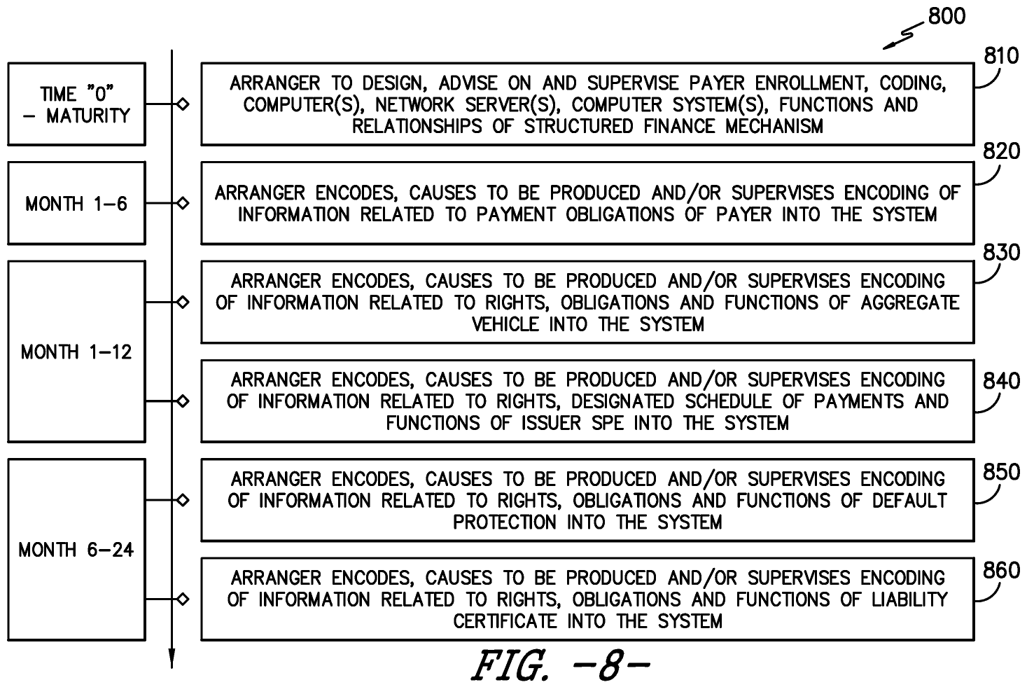

FIG. 8 illustrates a timeline 800 depicting functions of an arranger 105 in accordance with embodiments. Arranger 105 may design, advise on, and supervise 810 a system 100, coding, functions, and relationships of structured finance mechanism 100. Arranger 105 may then encode, cause to be produced and/or supervise 820 the encoding of information related to payment obligation 110 of at least one payer 102 into the system 100/arranger terminal 105t. Arranger 105 may then encode, cause to be produced and/or supervise 830 the encoding of information related to rights, obligations & functions of aggregation vehicle 213 into the system 200/arranger terminal 105t. Arranger 105 may then encode, cause to be produced and/or supervise 840 the encoding of information related to rights, designated schedule of payments and functions of issuer SPE 103 with monetization terminal 103t into the system 100/arranger terminal 105t and/or monetization terminal 103t. Arranger 105 may then encode, cause to be produced and/or supervise 850 the encoding of information related to rights, obligations, & functions of default protection 517 into the system 100/arranger terminal 105t/monetization terminal 103t. Arranger may then encode, cause to be produced and/or supervise 860 the encoding of information related to rights, obligations, & functions of liability certificates 518 into the system 100/arranger terminal 105t/monetization terminal 103t.

It is noted that specific steps in timeline 800 may occur at different times, an example of which is shown in FIG. 8. Step 810 may occur at a time up to maturity of the structured finance mechanism. Step 820 may occur from 1 month to 6 months after step 810 for example. Step 830 may occur from 1 month to 12 months after step 820 for example. Step 840 may occur from 1 month to 12 months after step 830 for example. Step 850 may occur from 6 months to 24 months after step 840 for example. Step 860 may occur from 6 months to 24 months after step 850 for example.

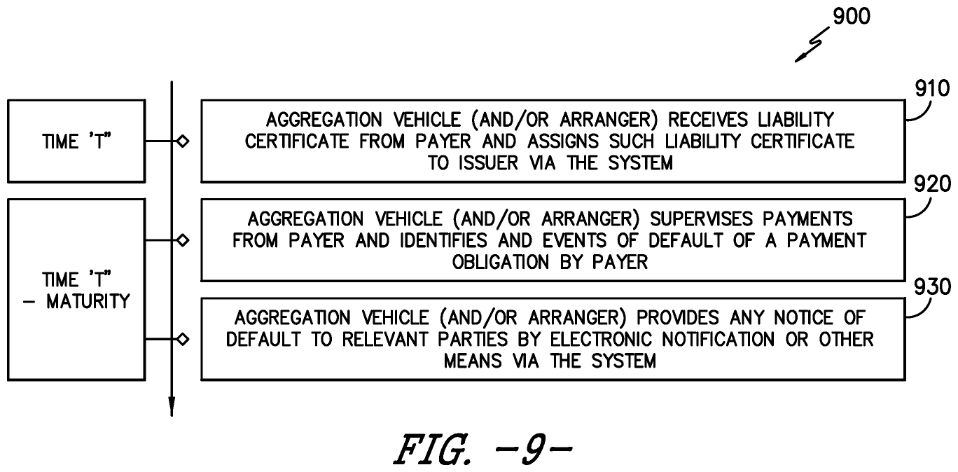

FIG. 9 illustrates a timeline 900 depicting functions of an aggregation vehicle 213 in accordance with embodiments. In embodiments, aggregation vehicle 213 and terminal 213t may perform the following functions in no particular order. Aggregation vehicle 213 and terminal 213t (and/or arranger terminal 105t) may receive 910 liability certificates 518 from payer 102 and may assign/send the liability certificates 518 to the monetization terminal 103t and/or arranger terminal 105t via the system 100. Aggregation vehicle 213 and terminal 213t (and/or arranger terminal 105t) may supervise 920 payments from payer 102 and may provide notice to relevant third parties of any event of default. Aggregation vehicle 213 (and/or arranger terminal 105t) may provide 930 notice of default to relevant parties by electronic notification or other means by, through, as instructed by, as recorded by and/or as stored on memory of the system 100.

It is noted that specific steps in timeline 900 may occur at different times, an example of which is shown in FIG. 9. Step 910 may occur at a time “T” and may be the time of a monetization transaction closing for example. Step 920 may occur from time “T” up to the time of maturity of step 910 for example. Step 930 may occur from time “T” up to the time of maturity of step 910 for example.

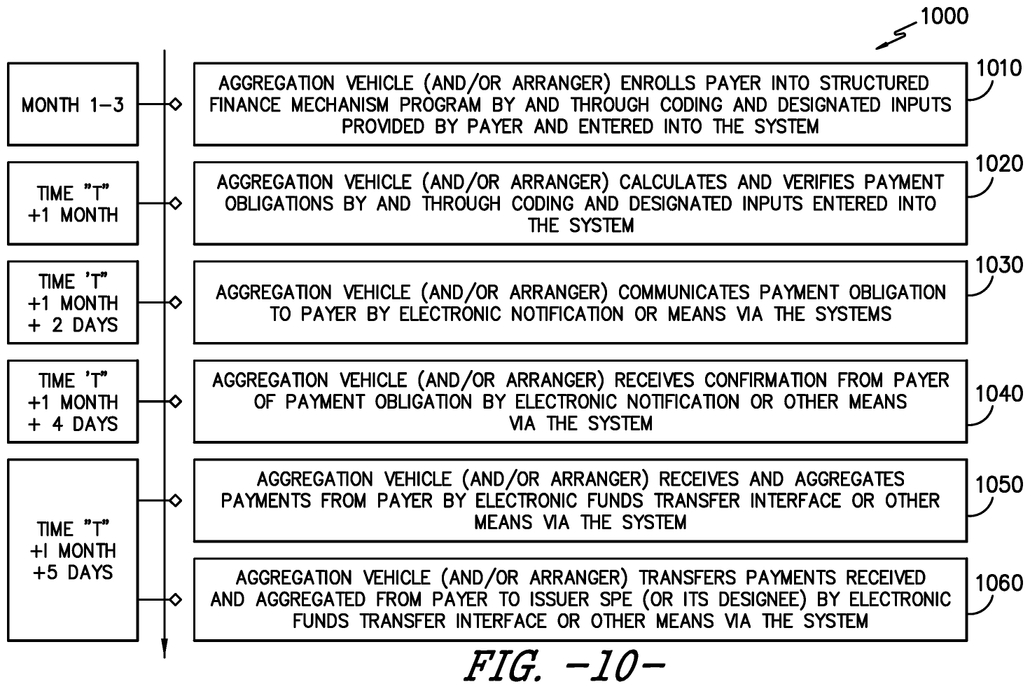

FIG. 10 illustrates a timeline 1000 depicting additional functions of an aggregation vehicle 213 in accordance with embodiments. Aggregation vehicle 213 (and/or arranger 105) may first enroll 1010 a payer 102 into a structured finance mechanism program via coding and designated inputs provided by payer 102 according to a payment agreement 101 and entered into the system 100/arranger terminal 105t/monetization terminal 103t. Aggregation vehicle 213 (and/or arranger terminal 105t) may then calculate 1020 and verify payment obligations via coding and designated inputs entered into the system 100/arranger terminal 105t/monetization terminal 103t. Aggregation vehicle 213 (and/or arranger terminal 105t) may then communicate 1030 payment obligation to payer 102 by electronic notification or other means via the system 100/arranger terminal 105t/monetization terminal 103t/payer terminal 102t. Aggregation vehicle 211 (and/or arranger terminal 104t) may then receive 1040 confirmation from payer 102 of payment obligation 110 by electronic notification or other means via the system 100/arranger terminal 105t/monetization terminal 103t. Aggregation vehicle 213 (and/or arranger terminal 105t) may then receive and aggregate 1050 payments from payer 102 by electronic funds transfer interface or by other means via the system 100/arranger terminal 105t/monetization terminal 103t. Aggregation vehicle 213 (and/or arranger terminal 105t) may then transfer 1060 aggregated payments 214 received from payer terminal 102t to monetization terminal 103t and/or arranger terminal 105t by electronic funds transfer interface or by other means via the system 100/arranger terminal 105t/monetization terminal 103t.

It is noted that specific steps in timeline 1000 may occur at different times, and example of which is shown in FIG. 10. Step 1010 may occur at a time between 1 and 3 months for example. Step 1020 may occur during 1 month after the 24-month mark of step 910 for example, which may be labeled as “T” and may be the time of a monetization transaction closing. Step 1030 may occur up to 2 days after step 1020 for example. Step 1040 may occur up to 2 days after step 1030 for example. Step 1050 may occur up to 1 day after step 1040 for example. Step 1060 may also occur up to 1 day after step 1040 for example.

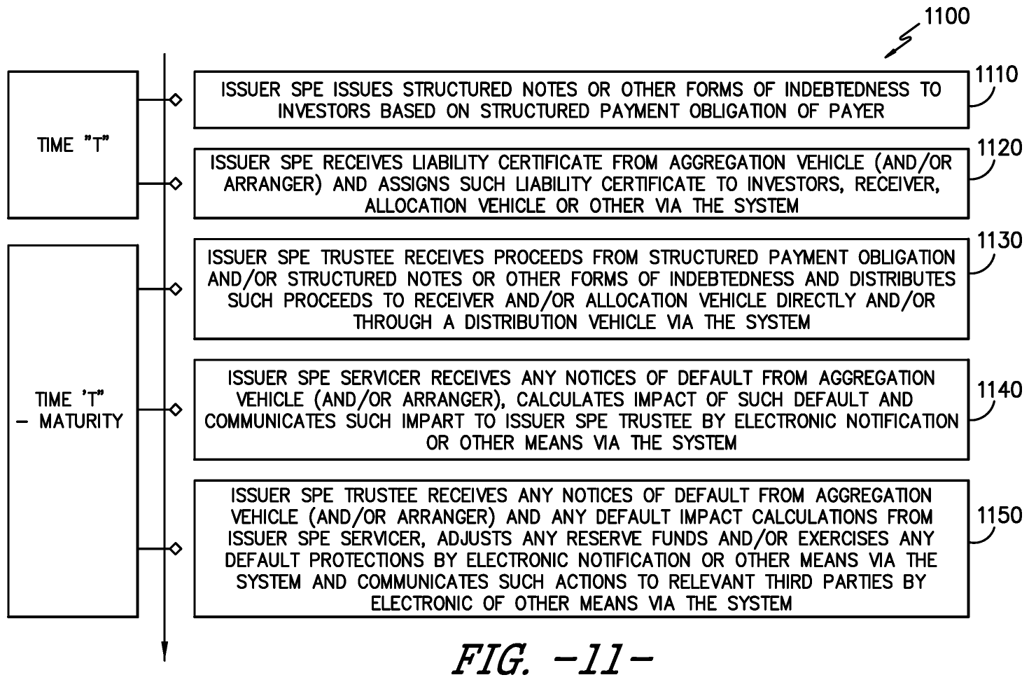

FIG. 11 illustrates a timeline 1100 depicting functions of an issuer SPE 103/monetization terminal 103t and/or arranger terminal 105t in accordance with embodiments. Issuer SPE 103/monetization terminal 103t may issue 1110 structured notes or other monetization transaction to investor terminals 108t based on payment obligations 110 of payer 102. Issuer SPE 103/monetization terminal 103t may receive 1120 liability certificates 518 from aggregation vehicle 213 (and/or arranger terminal 105t) and may assign the liability certificates 518 to investor terminals 108t, receiver terminals 104t, allocation vehicle 315 or other third parties via the system 100. Trustee terminal 106t associated with the issuer SPE 103/monetization terminal 103t may receive 1130 proceeds of structured notes or other monetization transaction from investors 108 and may administer proceeds 111 to receiver terminal 104t and/or allocation vehicle 315 either directly or through a distribution vehicle 511. Servicer terminal 107t associated with the issuer SPE 103/monetization terminal 103t may receive 1140 any notices of default from aggregation vehicle 213 (and/or arranger terminal 105), calculate impact of the default and communicate the impact to trustee terminal 106t by electronic notification or other means via the system 100. Trustee terminal 106t associated with the issuer SPE 103/monetization terminal 103t may receive 1150 any notices of default from aggregation vehicle 213 (and/or arranger terminal 105t) and any default impact calculations from servicer terminal 107t, adjust any reserve funds and/or exercise any default protections by electronic notification or other means and communicate such actions to relevant third-party terminals by electronic notification or other means via the system 100.

It is noted that specific steps in timeline 1100 may occur at different times, an example of which is shown in FIG. 11. Step 1110 may occur at a time “T” and may be the time of a monetization transaction closing for example. Step 1120 may occur at a time “T” and may be the time of a monetization transaction closing for example. Step 1130 may occur at a time “T” and may be the time of a monetization transaction closing for example. Step 1140 may occur from time “T” up to the time of maturity of steps 1110, 1120 and/or 1130 for example. Step 1150 may occur from time “T” up to the time of maturity of steps 1110, 1120 and/or 1130 for example.

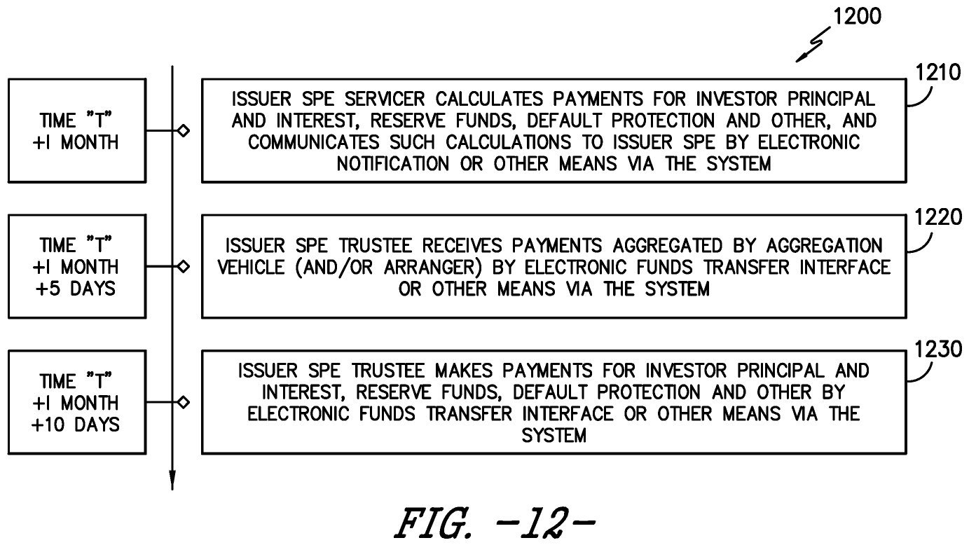

FIG. 12 illustrates a timeline 1200 depicting additional functions of an issuer SPE 103/monetization terminal 103t in accordance with embodiments. Servicer terminal 107t on behalf of issuer SPE 103/monetization terminal 103t may calculate 1210 payments for investor terminal 108t principal and interest, reserve funds, default protection and other, and may communicate the calculations to issuer SPE 103/monetization terminal 103t by electronic notification or other means via the system 100. Trustee terminal 106t associated with the issuer SPE 103/monetization terminal 103t may then receive 1220 payments aggregated by aggregation vehicle 213 (and/or arranger terminal 105t) by electronic funds transfer interface or other means via the system 100/trustee terminal 106t. Trustee terminal 106t associated with the issuer SPE 103/monetization terminal 103t may then administer 1230 payments to investor terminal 108t principal and interest, reserve funds, default protection and other by electronic funds transfer interface or other means via the system 100.

It is noted that specific steps in timeline 1200 may occur at different times, an example of which is shown in FIG. 12. Step 1210 may occur during 1 month after the 24-month mark of step 1110, 1120 and/or 1130, which may be labeled as “T” and may be the time of a monetization transaction closing for example. Step 1220 may occur up to 5 days after step 1210 for example. Step 1230 may occur up to 10 days after step 1220 for example.

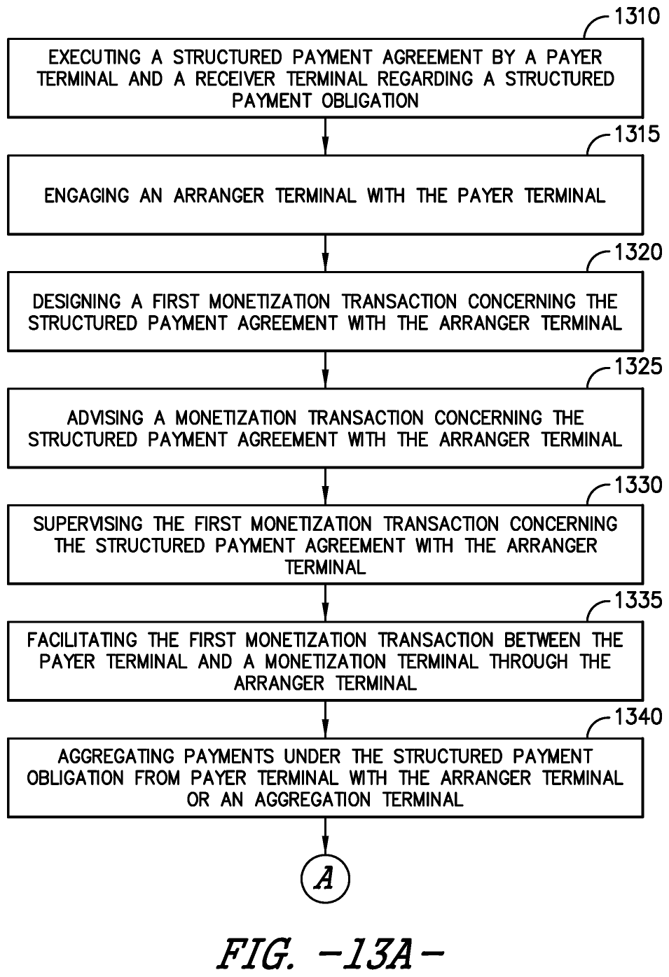

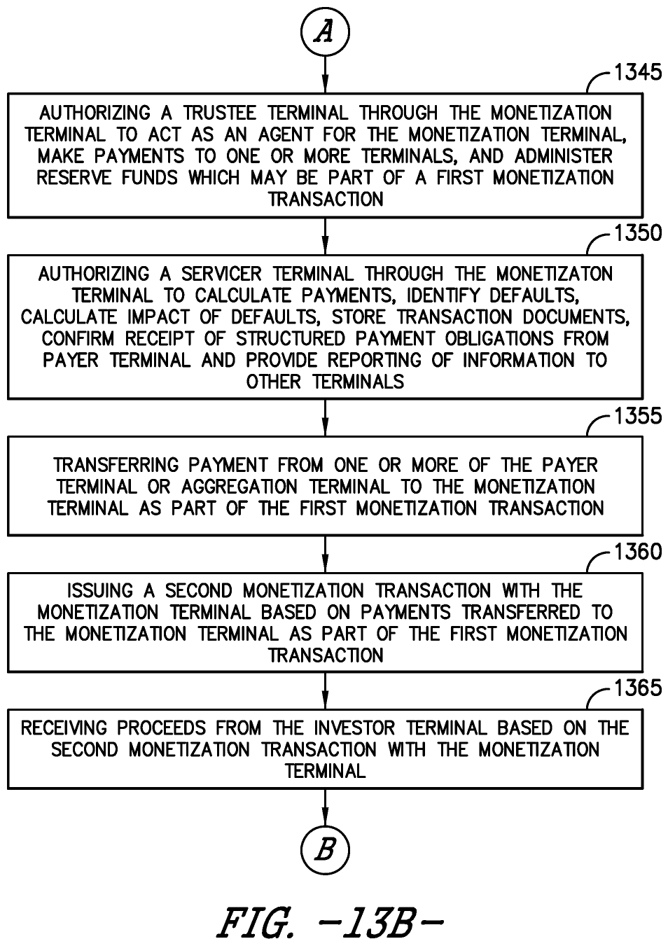

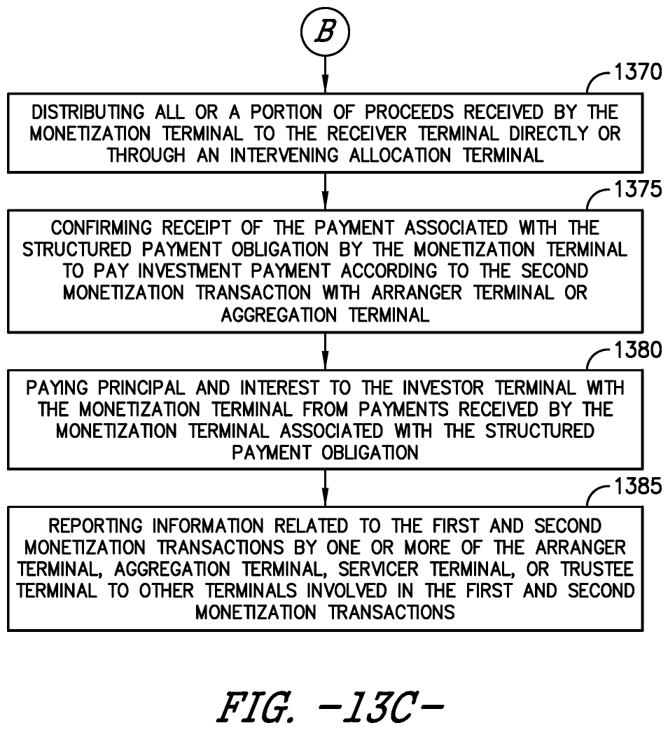

FIGS. 13A, 13B, and 13C illustrate a flowchart for a structured finance mechanism method by which at least one payer 102 monetizes at least one payment obligation 110 to distribute at least one proceeds 111 to at least one receiver 104 in accordance with embodiments. The exemplary method comprises executing 1310, by at least one payer terminal 102t and at least one receiver terminal 104t, at least one payment agreement 101. Once the payment agreement 101 is in place, an arranger terminal 105t may be engaged 1315 and may design 1320, advise on 1325 and supervise 1330 at least one monetization transaction. The monetization transaction may then be facilitated 1335 by the arranger terminal 105t between the at least one payer terminal 102t and the at least one monetization terminal 103t. During the facilitation 1335, aggregation 1340 of at least one payment obligation 110 from the at least one payer terminal 102t into at least one aggregated payment 214 is carried out by the arranger terminal 105t and/or an aggregation terminal 213t. Once aggregated 1340, the at least one aggregated payment 214 is transferred 1355 from the arranger terminal 105t and/or the aggregation terminal 213t to the at least one monetization terminal 103t. Prior to or after the transfer 1355, both a trustee terminal and servicer terminal may be authorized to be a part of the monetization transaction. The at least one aggregated payment 214 is transferred 1355 as input into the at least one monetization transaction.

After being transferred 1355, the at least one aggregated payment 214 is used by the at least one issuer SPE 103/monetization terminal 103t as the basis for issuing 1360 structured notes or other monetization transaction to at least one investor terminal 108t. In return for the issuing 1360, the monetization terminal 103t receives proceeds from the investor terminal 108t. Thereafter, the method contemplates distributing 1370 at least one proceeds 111 to the at least one receiver 104 and/or allocation terminal 315t, paying 1380 of principal and interest to the at least one investor terminal 108t and paying various other third parties involved in the monetization transaction for services provided to the at least one monetization transaction in the system 100. Subsequent to the issuer SPE 103/monetization terminal 103t distributing 1370 the at least one proceeds 111 to the at least one receiver 104 and/or allocation terminal 315t, arranger 105 and/or aggregation terminal 213t will confirm 1375 the at least one payment obligation 110 and the at least one aggregated payment 214 of the at least one payer 102 for transferring 1355 the at least one payment obligation 110 to the at least one issuer SPE 103/monetization terminal 103t for purpose of paying 1380 principal and interest and fees to various third parties for services provided to the monetization transaction in the system 100. In connection with functions related to the at least one monetization transaction, including but not limited to, aggregating 1340, transferring 1355, issuing 1360, distributing 1370, confirming 1375, paying 1380, arranger terminal 105t, aggregation terminal 213t, servicer terminal 107t and trustee terminal 106t will report 1385 information to various third parties related to the at least one monetization transaction.

In embodiments, any of the aforementioned systems may comprise the necessary components to carry out any of the disclosed methodologies. In order to carry out the methodologies, the systems may comprise a computer software product including a computer usable medium embodying computer readable code. The computer readable code may comprise computer code for carrying out instructions stored on the at least one payer terminal 102t, the arranger terminal 105t and/or the aggregation terminal 213t, the at least one monetization terminal 103t and the at least one receiver terminal 104t and/or allocation terminal 315t.

In embodiments, any use or reference to an example timeline is for purposes of illustration only and is not meant to be predictive, determinative, limiting, sequential, comprehensive, or mutually inclusive. Example timelines are provided by way of example only and are meant to illustrate a potential cumulative duration of time related to functions indicated and are not meant to indicate the actual duration of any given function or any component of a function. By way of example only, aggregation of a payment obligation 110 by arranger terminal 105t and/or aggregation terminal 213t from the at least one payer terminal 102t may occur over a period of 0 to 10 days, and once aggregated, such aggregated payment 214 could be transferred instantaneously by electronic funds transfer interface or other means by arranger terminal 105t and/or aggregation terminal 213t to monetization terminal 103t (or its assigns or designees) via the system 100.

In embodiments, elements appearing in one embodiment and not in another embodiment may be added to the other embodiment within the function of each system. By way of example only, in FIGS. 2A and 2B, an aggregation vehicle 213 may be utilized to aggregate the payment obligation 210 of a multiplicity of payers 202. Equally, in FIGS. 1A and 1B, an aggregation vehicle 213 such as that disclosed in the FIGS. 2A and 2B embodiment may be utilized in the FIGS. 1A and 1B embodiment to aggregate the payment obligation 110 of a single payer 102.

In embodiments, elements appearing in an embodiment may be removed within the function of each system. By way of example only, a certain Investor 108 may conduct the functions or an Arranger 105 of a structured note or other monetization transaction internally and may not require a separate Arranger element 105 so that an Arranger 107 such as that shown in FIG. 1A may be removed from this and other embodiments. By way of further example, a certain Investor 108 may conduct the Servicer function 107 of a structured note or other monetization transaction internally and may not require a separate Servicer element 107 so that a Servicer element 107 such as that shown in FIG. 1B may be removed from this and other embodiments. By way of further example, a certain Investor 208 may conduct the Trustee functions 206 of a structured note or other monetization transaction internally and may not require a Trustee element 206 so that a Trustee element 206 such as that shown in FIG. 2B may be removed from this and other embodiments. By way of further example, in FIGS. 3A and 3B, a monetization transaction between a single Payer 302 and a multiplicity of Receivers 304 may not require the services of a Credit Rating Agency 309 so that the Credit Rating Agency 309 element may be removed from this and other embodiments. By way of further example, an Investor 408 may act as a single, lead or direct investor in a monetization transaction so that such monetization transaction may not require a separate Issuer SPE 403 and an Issuer SPE 403 such as that shown in FIG. 4B may be removed from this and other embodiments. By way of further example, one or more Receivers 404 may not require a Distribution Vehicle 411 or an Allocation Vehicle 415 to receive or to distribute money or some other form of value from a monetization transaction so that such monetization transaction may not require a Distribution Vehicle 411 or an Allocation Vehicle 415 and such vehicles as shown in FIGS. 4A and 4B may be removed either individually or collectively from this and other embodiments. By way of further example, an Investor 408 or one or more Payers 402 may not require an Aggregation Vehicle 413 to make payment to or to provide funding for a monetization transaction so that such monetization transaction may not require an Aggregation Vehicle 413 and such vehicle as that shown in FIG. 4B may be removed from this and other embodiments. By way of further example, a certain Investor 508 may conduct Default Protection 517 of a structured note or other monetization transaction internally and may not require a separate Default Protection element 517 so that a Default Protection element 517 such as that shown in FIG. 5B may be removed from this and other embodiments. By way of further example, a Payment Agreement 501 or one or more Receivers 504, Investors 508 or Credit Rating Agency 509 may not require a Liability Certificate 518 in connection with a structured note or other monetization transaction so that a Liability Certificate 518 such as that shown in FIGS. 5A and 5B may be removed from this and other embodiments.

What is claimed is:

1. A financial structuring system utilizing a plurality of terminals within a computer network to monetize a payment obligation, said financial structuring system comprising:
at least one payment agreement having at least one payer terminal and at least one receiver terminal as parties thereto and concerning at least one payment obligation between said at least one payer terminal and at least one receiver terminal;
one or more third party terminals interfaced with said at least one payer terminal comprising at least one investor terminal; and
one or more monetization transactions by which said at least one payer terminal interacts with said one or more third party terminals causing at least a portion of said payment obligation to be assigned to said at least one investor terminal in exchange for investment proceeds and causing a portion of said investment proceeds to be distributed to said at least one receiver terminal.

2. The financial structuring system of claim 1, wherein said one or more third party terminals further comprise one or more arranger terminals to effectuate said at least one monetization transaction.

3. The financial structuring system of claim 1, wherein said one or more third party terminals further comprise one or more aggregation vehicle terminals to aggregate payments.

4. The financial structuring system of claim 3, wherein payments from said payer terminal under said payment obligation are passed through said one or more aggregation vehicle terminals prior to being received by said at least one investor terminal.

5. The financial structuring system of claim 1, wherein said one or more third party terminals further comprise one or more issuer SPE terminals issuing at least one of said monetization transactions to said at least one investor terminal.

6. The financial structuring system of claim 5, wherein said one or more issuer SPE terminals distributes a portion of said investment proceeds to said at least one receiver.

7. The financial structuring system of claim 1, wherein said one or more third party terminals further comprise one or more servicer terminals providing servicer functions in connection with said one or more monetization transactions.

8. The financial structuring system of claim 1, wherein said one or more third party terminals further comprise one or more trustee terminals providing trustee functions in connection with said one or more monetization transactions.

9. The financial structuring system of claim 1, wherein said one or more third party terminals further comprise one or more credit rating agency terminals providing credit rating services.

10. The financial structuring system of claim 1, wherein said one or more third party terminals further comprise one or more credit enhancement terminals providing credit enhancement to at least one of said one or more third party terminals and said at least one receiver terminal.

11. The financial structuring system of claim 1, wherein said one or more third party terminals further comprise one or more default protection terminals providing default protection to at least one of said one or more third party terminals and said at least one receiver terminal.

12. The financial structuring system of claim 11, wherein said one or more default protection terminals utilize one or more financial instruments to provide default protection.

13. The financial structuring system of claim 12, wherein said one or more financial instruments selected from the group consisting of a credit default contract, an option, a derivative, and an insurance product.

14. The financial structuring system of claim 1, wherein said one or more third party terminals further comprise one or more liability certificate terminals engaged to provide an agreement by said at least one payer terminal to be assigned to another terminal in said system and providing recourse for a breach of said at least one payment agreement by said at least one payer terminal.

15. The financial structuring system of claim 1, wherein said one or more third party terminals further comprise one or more distribution vehicle terminals through which said proceeds to be distributed to said at least one receiver terminal pass before being received by said one or more receiver terminals.

16. The financial structuring system of claim 1, further comprising one or more allocation vehicle terminals through which proceeds distributed to said at least one receiver terminal pass prior to being received by said at least one receiver terminal.

17. A method for structuring financial transactions to monetize a payment obligation, said method comprising the steps of:
providing a financial structuring system comprising at least one payer terminal, at least one receiver terminal, and at least one investor terminal;
executing at least one payment agreement with said at least one payer terminal and said at least one receiver terminal regarding said payment obligation;
facilitating at least one monetization transaction based on said payment obligation between said at least one payer terminal and said at least one receiver terminal;
issuing a monetization transaction for at least a portion of said at least one payment obligation in exchange for proceeds to at least one investor terminal;
receiving said proceeds from said at least one investor terminal;
transferring at least a portion of said at least one payment obligation to said at least one investor terminal; and
distributing at least a portion of said proceeds to said at least one receiver terminal.

18. The method of claim 17, wherein said financial structuring system further comprises at least one monetization terminal for facilitating said monetization transaction.

19. The method of claim 17, further comprising the step of engaging at least one arranger terminal to facilitate said at least one monetization transaction.

20. The method of claim 17, wherein said financial structuring system further comprises at least one aggregation terminal and said method further comprises the step of aggregating at least a portion of said payments from said at least one payer terminal to said at least one monetization terminal with said at least one aggregation terminal.

21. The method of claim 17, wherein said financial structuring system further comprises at least one servicer terminal providing servicer functions in connection with said at least one monetization transaction.

22. The method of claim 17, wherein said financial structuring system further comprises at least one trustee terminal providing trustee functions in connection with said at least one monetization transaction.

23. The method of claim 17, wherein said financial structuring system further comprises at least one credit rating agency terminal providing credit rating services in connection with said at least one monetization transaction.

24. The method of claim 17, wherein said financial structuring system further comprises at least one credit enhancement terminal providing protection to one or more of said one or more third party terminals and said at least one receiver terminals.

25. The method of claim 24, wherein said at least one credit enhancement terminal utilizes one or more financial instruments selected from the group consisting of default protection, a credit default contract, an option, a derivative, and an insurance product.

26. The method of claim 17, wherein said financial structuring system further comprises at least one liability certificate terminal providing an agreement by said at least one payer terminal that may be assigned to another terminal in said financial structuring system providing recourse for a breach of said at least one payment agreement by said at least one payer terminal.

27. The method of claim 17, wherein said financial structuring system further comprises at least one distribution vehicle terminal through which proceeds to be distributed to said at least one receiver terminal pass prior to being received by said at least one receiver terminal.

28. The method of claim 17, wherein said financial structuring system further comprises at least one allocation vehicle terminal through which proceeds to be distributed to said at least one receiver terminal pass prior to being received by said at least one receiver terminal.
